(19) United States
(12) Patent Application Publication
(10) Pub. No.: US 2015/0039341 A1
(43) Pub. Date: Feb. 5, 2015

(54) Invention includes the Process, Method and System for cloud-based critical Emergency and Discharge medical Information through the Capturing, Maintaining, Accessing, Integrating and Communicating said information

(71) Applicants: Fred Joel Markman, Canton, MI (US); James Gerard Trela, Wyandotte, MI (US)

(72) Inventors: Fred Joel Markman, Canton, MI (US); James Gerard Trela, Wyandotte, MI (US)

(21) Appl. No.: 13/958,539

(22) Filed: Aug. 3, 2013

(51) Int. Cl. G06F 19/00

(52) U.S. Cl. CPC G06F 19/322
USPC 705/3

(57) ABSTRACT

The invention brings together a new process to alert emergency personnel of a person's medical information and how to gain access to it. Access to the medical information is secure, requiring self-identification and biometrics. The invention facilitates communication of this medical information in many scenarios. The person's medical information must flow from the patient to the medical resources when an emergency situation exists; this could be an firefighter/paramedic or emergency room personnel. The medical information must also flow from the medical resource to the patient/caregiver or to the next medical organization taking responsibility for the continuing care of the patient. The invention also facilitates the communication of a child's allergies when they are in an adult moderated group setting (i.e. classrooms, team sports, etc.). The invention includes an integrated calendar and automated email process to ensure all concerned parties can coordinate ongoing care.

### CROSS REFERENCE TO RELATED APPLICATIONS SECTION

The following is a list of related patents.

| | PATENT | | |
|---|---|---|---|
| COUNTRY | NUMBER | NAME | DESCRIPTION |
| US | 6,523,009 | Individualized | A medical information record system |
| | | patient electronic | provides access to medical |
| | | medical records | information of persons in emergency |
| | | system | response situations. The system |
| | | | includes a portable data storage |
| | | | device (22) located in a carrier worn |
| | | | by a person. The portable data storage |
| | | | device contains current medical |
| | | | information records specific to the |
| | | | person wearing the device. A |
| | | | handheld reader (30) accesses the |
| | | | medical records contained in the |
| | | | portable data storage device via a |
| | | | probe (32) and a display for |
| | | | displaying the information to medical |
| | | | personnel. A distributed medical |
| | | | record database system (76) operates |
| | | | in conjuction with the reader and |
| | | | portable storage device for managing |
| | | | the personal medical informaion |
| | | | records. The distributed database |
| | | | system includes a central database |
| | | | location in communication with at |
| | | | least one localized database system |
| | | | location for coordination of medical |
| | | | records on a national scale. The |
| | | | distributed medical record database |
| | | | system includes the capability of |
| | | | creating and managing the personal |
| | | | medical records, and recording the |
| | | | personal medical records on the |
| | | | portable data storage device. |
| US | 7,321,862 | System and method for | A patient-worn monitoring system and |
| | | patient-worn | method for geographically dispersed health |
| | | monitoring of patients | care locations. A patient-worn monitoring |
| | | in geographically | system comprises a network, a body-worn |
| | | dispersed health care | monitoring station, a monitoring station |
| | | locations | server, a remote command center, and a rules |
| | | | engine. The network comprises a first sub- |
| | | | network and a second sub-network. The |
| | | | body-worn monitoring station comprises |
| | | | monitoring equipment. The body worn |
| | | | monitoring station monitors data elements |
| | | | from a patient assigned to a health care |
| | | | location and sends monitored data elements |
| | | | to a monitoring station server via the first |
| | | | sub-network. The monitoring station server |
| | | | receives the monitored data elements from |
| | | | the body worn monitoring station and relays |
| | | | the monitored data elements to the remote |
| | | | command center via the second sub-network. |
| | | | The remote command center receives the |
| | | | monitored data elements from the |
| | | | monitoring station server, associates the |
| | | | monitored data elements with the patient |
| | | | assigned to the health care location, accesses |
| | | | patient data elements indicative of a medical |
| | | | condition associated with the patient, and |
| | | | establishes a patient-specific rule associated |
| | | | with the patient. The rules engine selects data |
| | | | elements from the monitored data elements |
| | | | and the patient data elements associated with |
| | | | the patient and applies the patient-specific |
| | | | rule to the selected data elements |
| | | | continuously and simultaneously. A |
| | | | determination is made whether the patient- |
| | | | specific rule for the patient has been |
| | | | contravened. An alert is issued from the |
| | | | remote command center in the event the |
| | | | patient-specific rule for the patient has been |
| | | | contravened. |
| US | 7,778,848 | Electronic system for | |
| | | retrieving, displaying, | |
| | | and transmitting | |
| | | stored medical records | |
| | | from bodily worn or | |
| | | carried storage devices | |
| US | 8,145,644 | Systems and methods | Various aspects and embodiments of the |
| | | for providing access to | present invention relate to providing a |
| | | medical information | medical application with access to medical |
| | | | information from validated medical |
| | | | information experts. The medical information |
| | | | experts can be validated by scoring attributes |
| | | | of a purported medical information expert, |
| | | | generating a rank based on the score, and |
| | | | comparing the score to a pre-set threshold. |
| | | | The medical information from validated |
| | | | medical information experts can be stored in |
| | | | a knowledge database. A request from a |
| | | | medical application can be received and used |
| | | | to search the knowledge database to generate |
| | | | a response to the request that includes part of |
| | | | the medical information. The response can be |
| | | | provided to the medical application in a |
| | | | format that can be customized by the medical |
| | | | application. |
| US | 8,308,062 | Electronic medical | Various aspects and embodiments of the |
| | | information card and | present invention relate to providing a |
| | | system and method of | medical application with access to medical |
| | | use | information from validated medical |
| | | | information experts. The medical information |
| | | | experts can be validated by scoring attributes |
| | | | of a purported medical information expert, |
| | | | generating a rank based on the score, and |
| | | | comparing the score to a pre-set threshold. |
| | | | The medical information from validated |
| | | | medical information experts can be stored in |
| | | | a knowledge database. A request from a |
| | | | medical application can be received and used |
| | | | to search the knowledge database to generate |
| | | | a response to the request that includes part of |
| | | | the medical information. The response can be |
| | | | provided to the medical application in a |
| | | | format that can be customized by the medical |
| | | | application. |
| US | 8,405,518 | Universal personal | A universal personal emergency medical |
| | | emergency medical | information retrieval system, wherein |
| | | information retrieval | information is written onto an RFID tag that |
| | | system | is affixed to a carrier element, such as the |
| | | | back of the user's driver's license, passport, |
| | | | national identity card, school identification |
| | | | card, other form of identification, or cell |
| | | | phone. Medical personnel are alerted to the |
| | | | presence of the RFID tag by a universally |
| | | | accepted system identifier affixed to the |
| | | | carrier element, by scanning the patient with |
| | | | a handheld scanner, or by an RFID scanning |
| | | | portal. The emergency medical personnel can |
| | | | then download the user's information and |
| | | | identification photo using an RFID scanner. |
| | | | This information can then be used |
| | | | appropriately for proper emergency |
| | | | diagnosis and treatment. The RFID scanner |
| | | | can also be connected to a computer or |
| | | | computer network to retrieve additional |
| | | | information from a central database or to |
| | | | further disseminate the information |
| | | | contained on the RFID tag. |
| US | 8,461,988 | Personal emergency | A method of automatically requesting |
| | | response (PER) system | assistance for a patient includes wearing a |
| | | | wireless device with one or more |
| | | | accelerometers on the patient to detect |
| | | | patient motion; determining a fall based on |
| | | | detected motions; and automatically |
| | | | requesting assistance for the patient if |
| | | | needed. |
| US | 8,468,033 | Cloud-based | The present disclosure describes systems and |
| | | healthcare information | methods of a healthcare exchange system to |
| | | exchange | exchange medical information, stored in |
| | | | different formats, between different entities. |
| | | | This exchange system provides a channel for |
| | | | the flow of information and patient records |
| | | | across different health care entities that may |
| | | | store data in different formats. The exchange |
| | | | system's ability to receive requests and |
| | | | retrieve corresponding data from various |
| | | | entities, along with the transformation of data |
| | | | from the storing format into a format |
| | | | specified by the requesting entity, allow a |
| | | | flexible and extendable healthcare |
| | | | information exchange system. |
| US | 120185273 | Electronic complete | e-CHIF eliminates the inconsistency and |
| | (publication | health information | duplication of Patient Records by centralizing |
| | number) | facilitator 19.07.2012 | the data in only one place, the e-CHIF |
| | | | database. Using a web based portal, a health |
| | | | provider initially adds the patient record. The |
| | | | patient owns the data and makes it available |
| | | | to subsequent health providers including |
| | | | physicists, dentists, psychiatrics, and |
| | | | alternative medicine practitioners who add |
| | | | additional data to the patient record. |
| | | | Therefore a patient or an authorized health |
| | | | provider can view the complete health history |
| | | | of a person including conventional and |
| | | | alternative medicine treatments. Additionally, |
| | | | the health provider using the e-CHIF web site |
| | | | has the capability to electronically submit an |
| | | | insurance claim, request a prescription to a |
| | | | pharmacy, or a test to a laboratory. To assist |
| | | | the patient, health providers, and medical |
| | | | research several statistical reports without |
| | | | personal identifiable information can be |
| | | | generated using the e-CHIF data. |
| US | 20060206361 | System for maintaining | An individualized patient electronic medical |
| | (publication | patient medical | records system (10) that provides unlimited |
| | number) | records for | patient access to one's medical records (20). |
| | | participating patients | The invention may include a benchmark |
| | | | against which medical treatments can be |
| | | | evaluated for compliance with reasonable |
| | | | standard of care or a prompt to indicate |
| | | | appropriate testing, medications, etc., based |
| | | | upon the patient's age, sex, etc. The invention |
| | | | is applicable to human and animal patients. |
| | | | Advantages include patient ownership, |
| | | | control, and access to her/his individual |
| | | | records; the patient (22) can review and |
| | | | enter comments or questions on her/his data |
| | | | record for review and consideration by a |
| | | | physician; the patient can carry the medical |
| | | | record on her/his person so that the |
| | | | information is accessible in the event of |
| | | | emergency or when traveling; any entry to |
| | | | the medical records is identified by the |
| | | | provider (12, 14, 16, 24) or patient |
| | | | her/himself; and a password or similar |
| | | | prevents tampering or altering information |
| | | | entered by someone else. |
| US | 20070038477 | Maintaining and | A portable heath care records system |
| | (publication | communicating health | employs a server on which the health care |
| | number) | information | records of participating patients are stored. |
| | | | The patients may access the system using |
| | | | cards or CD-ROMS that are inserted into the |
| | | | patient's computer. The patients can review |
| | | | their own records via Internet and can edit |
| | | | them. The patient may also access via cell |
| | | | phone or handheld device. The patient record |
| | | | is protected by patient ID and password. |
| | | | Treating physicians have access to each |
| | | | patient's records for review and update. A |
| | | | two-way firewall permits patients to review |
| | | | their own health records only, but permits |
| | | | the physician to review both the physician |
| | | | files and the patient files. The physician can |
| | | | override the firewall to send patient |
| | | | information from his or her record. A read- |
| | | | only emergency screen with medical data |
| | | | about the patient may be accessed for |
| | | | emergency use. Records of many patients and |
| | | | of many clinics are maintained on a common |
| | | | server, so that the patient record can be |
| | | | accessed globally. |
| US | 20070046476 | System providing | A patient record is created from data received |
| | (publication | medical personnel | from a network device and is stored in a |
| | number) | with immediate critical | database. The data represents patient |
| | | data for emergency | information and possibly other personal data. |
| | | treatments | A plurality of access privileges may be |
| | | | associated with the patient record, each of |
| | | | which may specify a different type or amount |
| | | | of the data of the patient record that can be |
| | | | viewed, updated and revised. A selected |
| | | | portion of the patient record may be |
| | | | designated as emergency information that |
| | | | would be helpful to a caregiver during a |
| | | | medical emergency. An emergency reference |
| | | | code can be associated with the emergency |
| | | | information. In response to receiving the |
| | | | emergency reference code from a user device |
| | | | via the network, the emergency information |
| | | | may be displayed. An interface is also |
| | | | provided for allowing a user having |
| | | | appropriate access privileges to create and |
| | | | print a customized card comprising portions |
| | | | of the patient record selected by the user. |
| US | 20070250348 | SYSTEM AND METHOD | A medical data management system includes: |
| | (publication | OF AGGREGATING | a personal information database storing |
| | number) | AND DISSEMINATING | medical record information regarding |
| | | IN-CASE-OF- | medical data of a patient while managing the |
| | | EMERGENCY MEDICAL | information using an ID number; a medicine |
| | | AND PERSONAL | information database storing medicine |
| | | INFORMATION | information regarding medicines; a medical |
| | | | institution information database storing |
| | | | institution information regarding medical |
| | | | institutions; and a means for retrieving |
| | | | medical record information from the personal |
| | | | information database on the basis of an input |
| | | | of the ID number, retrieving medicine |
| | | | information corresponding to medicine |
| | | | names in the medical record information |
| | | | from the medicine information database to |
| | | | create a medical record distribution |
| | | | document, and distributing the medical |
| | | | record distribution document to an |
| | | | emergency medical institution into which the |
| | | | patient has been carried, on the basis of the |
| | | | medical institution information database. In |
| | | | such a medical data management system, the |
| | | | personal information database stores medical |
| | | | data for individuals who desire registrations. |
| US | 20070282631 | for aggregating and | A system for aggregating and disseminating |
| | (publication | providing subscriber | in-case-of-emergency (ICE) medical |
| | number) | medical information to | information to medical units. The system |
| | | medical units | includes an ICE medical record server that |
| | | | stores medical records of respective |
| | | | subscribers, and automatically receive |
| | | | updates from health service entities visited |
| | | | by subscribers. When contacted by |
| | | | emergency dispatchers or first responders, |
| | | | the server sends subscribers medical |
| | | | information to first responders, emergency |
| | | | management agencies directly, via a |
| | | | dispatcher, or via a computer aided dispatch |
| | | | (CAD) system. The medical information may |
| | | | be arranged, emphasized, and/or filtered in a |
| | | | manner relevant to the on-going emergency. |
| | | | A communication device may wirelessly |
| | | | receive the medical information and pre- |
| | | | populate a pre-hospital care form with the |
| | | | information, which may be further orally |
| | | | annotated by the first responder. The |
| | | | completed PCR may then be sent to a PCR |
| | | | server for subsequent access by medical units |
| | | | that subsequently treat the subscriber. The |
| | | | medical server may further assist a public |
| | | | health agency to disseminate emergency |
| | | | information to selected subscribers, |
| | | | responders, and public health alerting |
| | | | systems. An ICE personal server for storing |
| | | | important personal documents is also |
| | | | disclosed. A PCR server is also disclosed that |
| | | | can disseminate aggregate PCR information in |
| | | | near real-time to an emergency management |
| | | | agency (EMA) system for developing incident |
| | | | response plans during a wide area |
| | | | emergency. |
| US | 20080215373 | SYSTEM AND METHOD | According to the invention, records |
| | (publication | FOR AGGREGATING | pertaining to an individual are centralized |
| | number) | AND PROVIDING | such that the user has control over the |
| | | SUBSCRIBER MEDICAL | integration and dissemination of their |
| | | INFORMATION TO | personal and private information. Records |
| | | MEDICAL UNITS | pertaining to an individual are systematically |
| | | | transported electronically by many different |
| | | | institutions to a centralized record storage |
| | | | provider wherein the individual user has |
| | | | ownership of and control of their confidential |
| | | | personal information. The systematic |
| | | | accumulation of medical records provides for |
| | | | better overall health tracking and faster and |
| | | | more accurate diagnosis when illness or |
| | | | emergency occurs. |
| US | 20080243545 | SYSTEM AND METHOD | A system and method for aggregating and |
| | (publication | OF AGGREGATING | providing subscriber medical record |
| | number) | AND DISSEMINATING | information to medical units. The system |
| | | IN-CASE-OF- | includes an ICE medical record server that |
| | | EMERGENCY MEDICAL | stores a plurality of medical records of |
| | | AND PERSONAL | respective subscribers. When a subscriber is |
| | | INFORMATION | being attended by a medical unit, the medical |
| | | | unit using a communication device sends an |
| | | | identification number to the server. In |
| | | | response, the server sends the subscriber's |
| | | | medical record to the communication device. |
| | | | The communication device may populate a |
| | | | medical form with the information and |
| | | | display it for use in diagnosing and treating |
| | | | the subscriber. The medical unit may |
| | | | annotate the medical form to document the |
| | | | on-going emergency, and upload it to a |
| | | | professional medical record server, which |
| | | | may provide the information to a medical |
| | | | facility to which the subscriber will be |
| | | | transported. The ICE and/or professional |
| | | | medical record servers may perform |
| | | | statistical analyses of the information in their |
| | | | respective databases for the purpose of |
| | | | performing symptomatic surveillance and |
| | | | other public health analyses. |
| US | 20080319798 | PERSONALIZED | A system for aggregating and disseminating |
| | (publication | MEDICAL | in-case-of-emergency (ICE) medical |
| | number) | INFORMATION CARD | information to medical units. The system |
| | | AND METHOD FOR | includes an ICE medical record server that |
| | | MANAGING SAME | stores medical records of respective |
| | | | subscribers, and automatically receive |
| | | | updates from health service entities visited |
| | | | by subscribers. When contacted by |
| | | | emergency dispatchers or first responders, |
| | | | the server sends subscribers medical |
| | | | information to first responders, emergency |
| | | | management agencies directly, via a |
| | | | dispatcher, or via a computer aided dispatch |
| | | | (CAD) system. The medical information may |
| | | | be arranged, emphasized, and/or filtered in a |
| | | | manner relevant to the on-going emergency. |
| | | | A communication device may wirelessly |
| | | | receive the medical information and pre- |
| | | | populate a pre-hospital care form with the |
| | | | information, which may be further orally |
| | | | annotated by the first responder. The |
| | | | completed PCR may then be sent to a PCR |
| | | | server for subsequent access by medical units |
| | | | that subsequently treat the subscriber. The |
| | | | medical server may further assist a public |
| | | | health agency to disseminate emergency |
| | | | information to selected subscribers, |
| | | | responders, and public health alerting |
| | | | systems. An ICE personal server for storing |
| | | | important personal documents is also |
| | | | disclosed. A PCR server is also disclosed that |
| | | | can disseminate aggregate PCR information in |
| | | | near real-time to an emergency management |
| | | | agency (EMA) system for developing incident |
| | | | response plans during a wide area |
| | | | emergency. |
| US | 20090198696 | Emergency medical | A method for managing an individual's |
| | (publication | record | personal medical information includes |
| | number) | | creating an online medical information record |
| | | | which contains the individual's stored |
| | | | personal medical information, providing the |
| | | | individual with a physical credit card sized |
| | | | card which includes the individual's key |
| | | | medical information from the individual's |
| | | | online medical information record that would |
| | | | be most needed in times of medical |
| | | | emergency and directions for accessing the |
| | | | individual's online medical information |
| | | | record, enabling the individual to update his |
| | | | or her online medical information record with |
| | | | the individual's most recent medical |
| | | | information; and enabling the individual and |
| | | | others to view a read only version of the |
| | | | individual's online medical information |
| | | | record. |
| US | 20120179856 | medstick, e-medstick, | A system and retrieval of an emergency |
| | (publication | e-medstick EMR | medical record of a patient comprising the |
| | number) | | step of receiving the emergency medical |
| | | | record of the patient and an online database. |
| | | | The system further comprises the step of |
| | | | storing the emergency medical record in the |
| | | | online database and providing access to the |
| | | | online database by using a communications |
| | | | network. Access to the network is provided |
| | | | by entering a member number and a unique |
| | | | user defined validation code to maximize |
| | | | privacy and security. The system further |
| | | | comprises the step of retrieving the |
| | | | emergency medical record at the online |
| | | | database. The system comprises the final step |
| | | | of providing the emergency medical record to |
| | | | a requestor by one of the following methods: |
| | | | viewing the online display, printing the online |
| | | | display, faxing the emergency medical record |
| | | | to a requester, and e-mailing the emergency |
| | | | medical record to a requestor. The method |
| | | | may further comprise the step of entering the |
| | | | record delivery information including the fax |
| | | | number and at least one of the following: the |
| | | | facility name, the requestor name, and the |
| | | | facility phone number. |
| US | 20130035581 | AUGMENTED REALITY | A portable, electronic and encrypted medical |
| | (Publication | ENHANCED TRIAGE | record device and management system (10) |
| | number) | SYSTEMS AND | that receives and stores a registrant's or |
| | | METHODS FOR | patient's medical history (1401-1507) in a |
| | | EMERGENCY MEDICAL | secured database (1-300), records the |
| | | SERVICES | medical history on a portable computer |
| | | | readable medical storage device (200-300), |
| | | | includes a multi-level encrypted security |
| | | | system to control access to the medical |
| | | | information on the storage device or in the |
| | | | system for authorizing modification or access |
| | | | to the medical information (100-1507), |
| | | | allows authorized medical personnel to |
| | | | update recently acquired medical data (100- |
| | | | 1507), dictates the data that authorized |
| | | | medical entities or personnel have access to |
| | | | and includes a recognizable logo to alert |
| | | | medical personnel of the medical storage |
| | | | device (100-1507). |
| US | 20130103727 | Accessible Information | A system and method for aggregating and |
| | (publication | System | providing subscriber medical record |
| | number) | | information to medical units. The system |
| | | | includes an ICE medical record server that |
| | | | stores a plurality of medical records of |
| | | | respective subscribers. When a subscriber is |
| | | | being attended by a medical unit, the medical |
| | | | unit using a communication device sends an |
| | | | identification number to the server. In |
| | | | response, the server sends the subscriber's |
| | | | medical record to the communication device. |
| | | | The communication device may populate a |
| | | | medical form with the information and |
| | | | display it for use in diagnosing and treating |
| | | | the subscriber. The medical unit may |
| | | | annotate the medical form to document the |
| | | | on-going emergency, and upload it to a |
| | | | professional medical record server, which |
| | | | may provide the information to a medical |
| | | | facility to which the subscriber will be |
| | | | transported. The ICE and/or professional |
| | | | medical record servers may perform |
| | | | statistical analyses of the information in their |
| | | | respective databases for the purpose of |
| | | | performing symptomatic surveillance and |
| | | | other public health analyses. |
| EP | 2479693 | Method of managing | A device stores a patient's medical records to |
| | | health information | solve the problems of incompatibility of |
| | | | electronic medical record systems, no patient |
| | | | information available at emergencies, lack of |
| | | | information sharing among physicians, and |
| | | | health care fraud. The device includes a flash |
| | | | drive configured to connect to a USB port and |
| | | | be read by a computer, a record of emergency |
| | | | patient data photo stored on the flash drive |
| | | | and displayed immediately by the computer |
| | | | when the flash drive is inserted into the USB |
| | | | port, and a record of detailed data stored on |
| | | | the flash drive and displayed upon entry of a |
| | | | correct password and identification. |
| JP | 2002007562 | METHOD AND DEVICE | An individualized patient electronic medical |
| | (publication | FOR SUPPORTING | records system that provides unlimited |
| | number) | EMERGENCY MEDICAL | patient access to her/his medical records, |
| | | TREATMENT | including text and other data. Additionally, |
| | | | the invention may include a benchmark |
| | | | against which medical treatments can be |
| | | | evaluated for compliance with reasonable |
| | | | standard of care or a prompt to indicate |
| | | | appropriate testing, medications, etc., based |
| | | | upon the patient's age, sex, etc. Also, the |
| | | | invention is applicable to human patients and |
| | | | to animal patients. Advantages of the |
| | | | invention include patient ownership, control, |
| | | | and access to her/his individual records at |
| | | | any time. Also, the patient can review and |
| | | | enter comments or questions on her/his data |
| | | | record for review and consideration by a |
| | | | physician. Furthermore, the patient can carry |
| | | | the medical record on her/his person so that |
| | | | the information is readily accessible in the |
| | | | event of an emergency or if s/he were |
| | | | traveling. Finally, any entry to the medical |
| | | | records is coded or identified by the provider |
| | | | or patient her/himself, and a password or |
| | | | other write-protect means prevents |
| | | | tampering or altering information entered by |
| | | | someone else. |
| JP | 200708028 | MEDICAL DATA | A system and method for aggregating and |
| | (publication | MANAGEMENT | providing subscriber medical record |
| | number) | SYSTEM | information to medical units The system |
| | | | includes an ICE medical record server that |
| | | | stores a plurality of medical records of |
| | | | respective subscribers. When a subscriber is |
| | | | being attended by a medical unit, the medical |
| | | | unit using a communication device sends an |
| | | | identification number to the server. In |
| | | | response, the server sends the subscribers |
| | | | medical record to the communication device. |
| | | | The communication device may populate a |
| | | | medical form with the information and |
| | | | display it for use in diagnosing and treating |
| | | | the subscriber. The medical unit may |
| | | | annotate the medical form to document the |
| | | | on-going emergency, and upload it to a |
| | | | professional medical record server, which |
| | | | may provide the information to a medical |
| | | | facility The record servers may perform |
| | | | statistical analyses of the information in their |
| | | | respective databases for symptomatic |
| | | | surveillance and other public health analyses. |
| WO | 2004044778 | INDIVIDUALIZED | An individualized patient electronic medical |
| | (publication | PATIENT ELECTRONIC | records system that provides unlimited |
| | number) | MEDICAL RECORDS | patient access to her/his medical records, |
| | | SYSTEM | including text and other data. Additionally, |
| | | | the invention may include a benchmark |
| | | | against which medical treatments can be |
| | | | evaluated for compliance with reasonable |
| | | | standard of care or a prompt to indicate |
| | | | appropriate testing, medications, etc., based |
| | | | upon the patient's age, sex, etc. Also, the |
| | | | invention is applicable to human patients and |
| | | | to animal patients. Advantages of the |
| | | | invention include patient ownership, control, |
| | | | and access to her/his individual records at |
| | | | any time. Also, the patient can review and |
| | | | enter comments or questions on her/his data |
| | | | record for review and consideration by a |
| | | | physician. Furthermore, the patient can carry |
| | | | the medical record on her/his person so that |
| | | | the information is readily accessible in the |
| | | | event of an emergency or if s/he were |
| | | | traveling. Finally, any entry to the medical |
| | | | records is coded or identified by the provider |
| | | | or patient her/himself, and a password or |
| | | | other write-protect means prevents |
| | | | tampering or altering information entered by |
| | | | someone else. |
| WO | 2007030605 | SYSTEM AND METHOD | An RFID transponder on a person or animal |
| | (publication | FOR AGGREGATING | provides the health care or security |
| | number) | AND PROVIDING | personnel with the critical information when |
| | | SUBSCRIBER MEDICAL | the personnel employs a reader terminal |
| | | INFORMATION TO | capable of reading the RFID transponder. The |
| | | MEDICAL UNITS | transponder, after being interrogated by the |
| | | | reader, supplies the critical data such as |
| | | | name, blood type, allergies, directives, |
| | | | medicines, and emergency contact numbers. |
| | | | The reader immediately displays such critical |
| | | | information on its screen. The RFID tag can |
| | | | substantiate that it belongs to its owner. This |
| | | | identification process can involve biometric |
| | | | analysis. The reader terminal downloads |
| | | | additional data from a server and the |
| | | | additional data is presented on a reader |
| | | | terminal's screen. The server queries the |
| | | | wireless carrier for reader terminal's location |
| | | | data, correlates the reader location data with |
| | | | hospital location data, and sends the critical |
| | | | information to the nearby hospitals. |
| | | | Additionally, the server sends alert |
| | | | information to other firms or individuals |
| | | | contained in the transponder wearer's data |
| | | | record. The RFID tag is the healthcare record. |
| | | | It relates and integrates into a larger database |
| | | | and network. It proves its owner and through |
| | | | wireless technology identifies location and |
| | | | other data characteristics of its owner. |
| WO | WO/2012/129265 | ENCRYPTED | Method of managing health information, the |
| | (publication | PORTABLE | method comprising maintaining a personal |
| | number) | ELECTRONIC | health record for an individual by a provider |
| | | MEDICAL RECORD | and authorizing access to the personal health |
| | | SYSTEM | record in response to a medical emergency, |
| | | | wherein the method further comprises |
| | | | transmitting a location of the individual to the |
| | | | provider. |

### BACKGROUND OF THE INVENTION SECTION

1. Field of the Invention

Our invention relates to a process, method and system for managing and communicating critical healthcare information as it relates to emergency and discharge situations. More particularly, the present invention relates to the capturing, maintaining, accessing, communicating, and integrating the critical information in support of the emergency and discharge information in a cloud based environment supporting not only the patient and family but also all healthcare facilities.

2. Why this is Needed:
In an emergency/911 situation:
   People do not have current critical medical information in case of an emergency (communications between patient/caregiver and emergency personnel—Emergency Medical Technicians or Emergency Rooms)
   In certain emergency situations it is impossible to identify the injured individual. Through real time access a person will not only be identified but their current medical information will be made available as well.
   Studies have shown that less than 2% of people have the current medical information available during an emergency situation. With the advent of the internet and advancements in technology access and security, individuals can now capture and provide access to their families and their healthcare providers.
   Current cloud-based applications fail to provide the information integrating the discharge function with the current medical information for an individual.
   Current cloud-based applications fail to provide an integrated email system to communicate the health care information to all of the required health care providers and/or caregivers.
   Provides an interface to identify and access a registered person's current medical information.
In discharge situations:
   Discharge information not communicated well to (understood by) patient/caregiver
   Discharge information not comprehensive to other medical providers/living facilities
   Patients/caregivers do not follow the discharge instructions
   There is a shift in responsibility of individual health care management to the individual due to rising costs and policy changes associated with health care, especially for the elderly
   Current cloud-based applications are not communicating discharge information to the patient, their family, nor to all of the health care providers.
In children having allergic reactions under the care of someone other than their parent or guardian:
   Responsible individuals for children do not have up to date allergy information and that leads to putting the child at risk

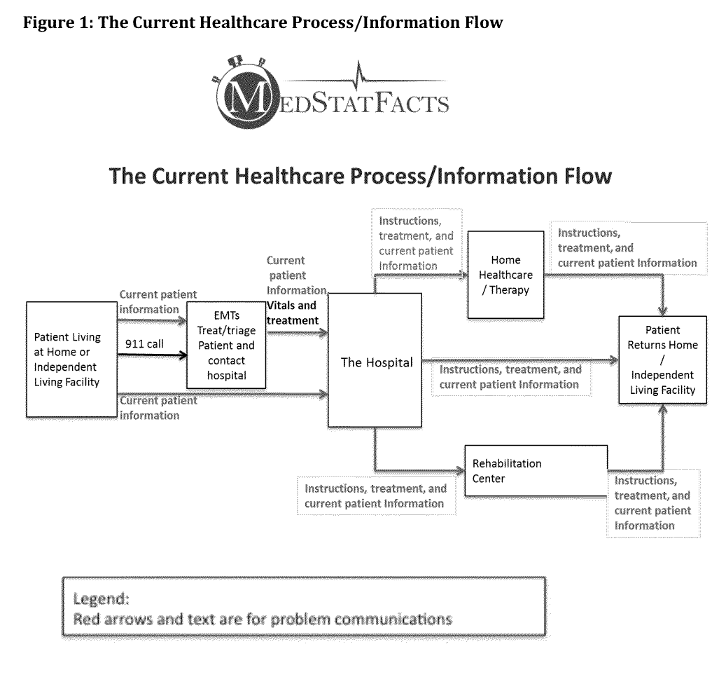

See, FIG. 1: the Current Healthcare Process/Information Flow in the Drawing document on page 2.

### The Unique Problem this Solves and how

Problems we are Solving:
1. Communication Problems Regarding Critical Personal Medical Information
   Person does not have current critical medical information in case of an emergency (communications between patient/caregiver and emergency personnel—EMTs or Emergency rooms)
      EMS Ready Kit
      Registry
   Discharge information not communicated well to (understood by) patient/caregiver
      Discharge action item list for patient/caregiver
   Discharge information not comprehensive to other medical providers/living facilities
      Discharge instructions in registry based on comprehensive checklist
      There is no integration of medical information of a person's current medical information in an emergency situation with the discharge information.
   Registry—same registry for discharge as current medical information for patient/caregiver, EMTs, hospital ER, hospital discharge, and other medical providers.
   Drug interactions—list of new prescriptions with current medications
   EMTs now have a mini emergency room with new technology in their ambulance, but without the current patient information they are limited in the treatment of the individual.
   Ability to identify an individual at the scene of an accident in real time
   Notifying first responders where current critical medical information of the patient can be found is a problem, if it exists.
      The Emergency Medical Technician Alert sticker, a sticker that is placed on a doorknob hanger on the front door, notifies first responders that current medical information can be found on the refrigerator
      Integration with the 911 dispatch center. MedStatFacts notifies the local 911 dispatch center to communicate when a emergency call comes in that the current medical information can be found on the refrigerator. A note is added to the local 911 system that states in case of an emergency call the current medical information can be found on the refrigerator.
      If a medical emergency occurs away from the house, medical information is not readily available to emergency room personnel nor first responders. Through our emergency room sticker, placed on an insurance or identification card, the medical personnel can access the current medical information online and print the medical profile of the patient.

2. Patient Accountability
Integrated email system with reminders and notifications for maintaining current critical medical information and completing discharge action items
Reminders of inactivity will help ensure the patient/caregiver to maintain the information in the registry
Documenting medical incidents with a detailed description and the resolution.

3. Remembering Medical Appointments
Integrated email system with reminders of upcoming medical events for patient and caregivers.

4. Children Away from Home Having an Allergic Reaction/Non Parent-Guardian in Charge of a Child and not Knowing Allergies or Treatment
Need based medical information on child allergies and appropriate treatment.

5. Patient Identification in an Emergency Situation
Through fingerprinting technology we can identify the patient. Also, we are capturing unique physical characteristics to help identify the person such as birthmarks, photos, and other distinguishing physical characteristics.

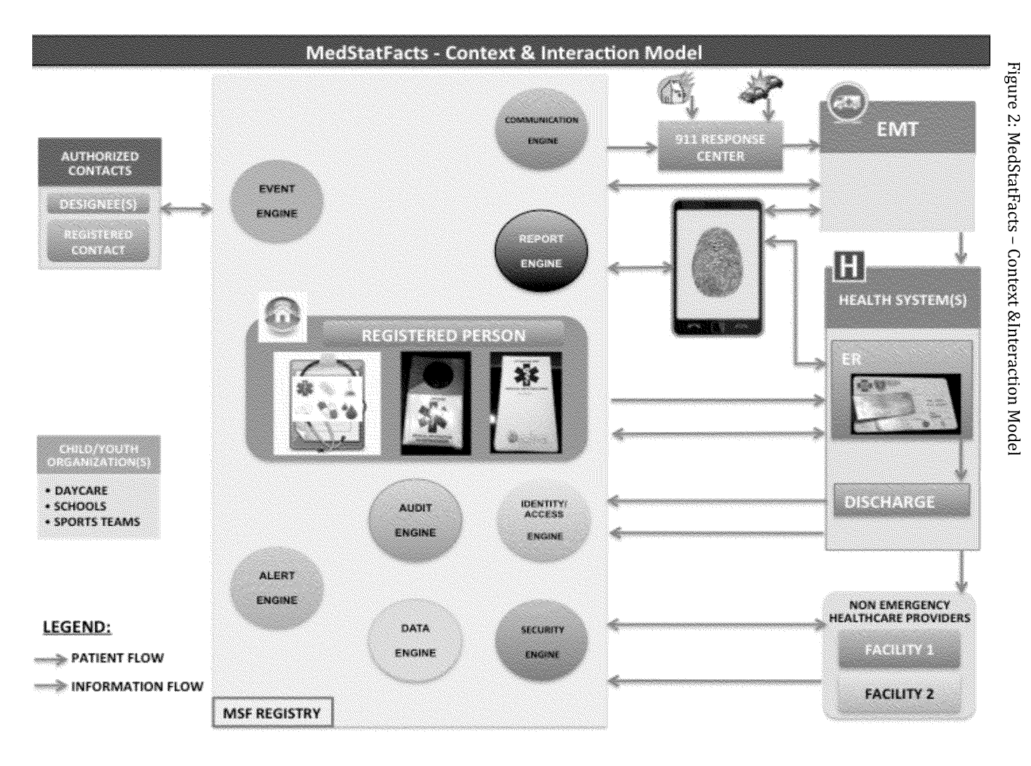

See FIG. 2: MedStatFacts Context and Interaction Model in the Drawing document page 3.

### BRIEF DESCRIPTION OF DRAWINGS SECTION

FIG. 1: The Current Healthcare Process/Information Flow
This drawing defines how the current flow of information happens today in the health care industry. It is used to show the problem areas in the information flow.

FIG. 2: The MedStatFacts—Context & Interaction Model
This diagram depicts the interactions between the product and the different people/functions interactions.

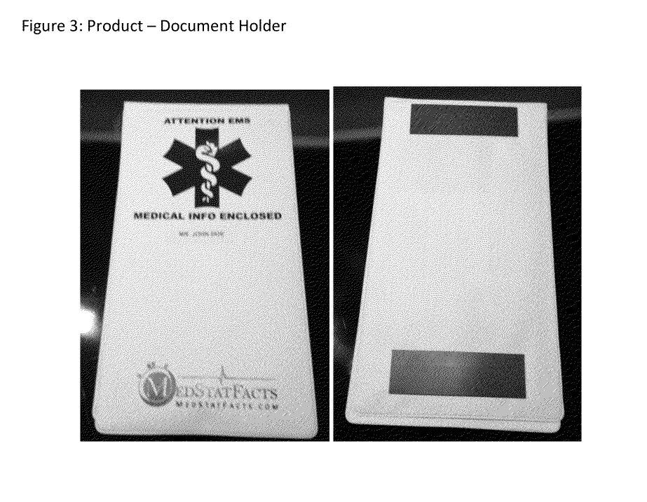

FIG. 3: The Product—Document Holder
This diagram shows the physical part of the product. The document holder is where a person would place their medical profile. This will reside on a refrigerator.

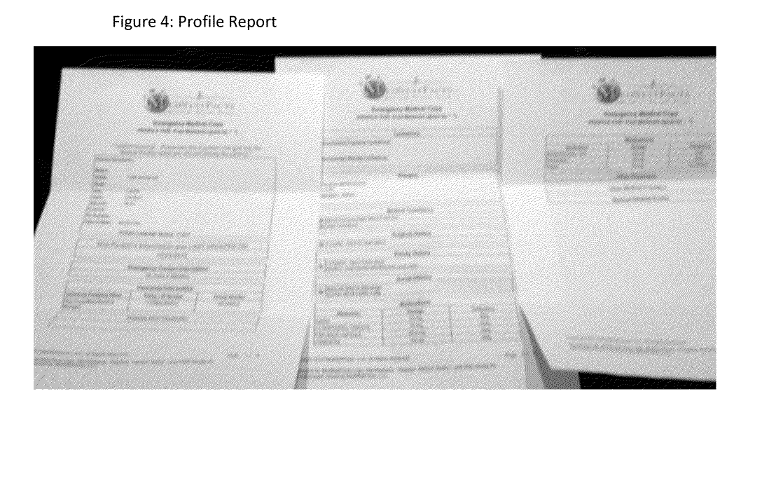

FIG. 4: The Profile Report
This is the document where the medical profile of the individual is shown. It is placed in the document holder.

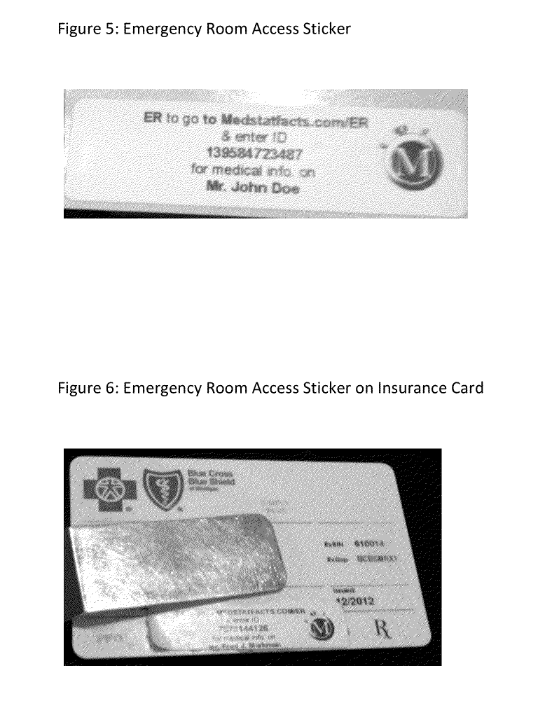

FIG. 5: The Emergency Room Access Sticker
This is a sticker that is placed on the individual's insurance card. (note it may be placed on any identification card). It contains a special URL and code where once typed into a computer the individual's profile comes up as a pdf file and may be printed. It is intended for Emergency Room personnel when the original profile is not available.

FIG. 6: The Emergency Room Access Sticker on Insurance Card
This just shows the above emergency room sticker residing on an insurance card.

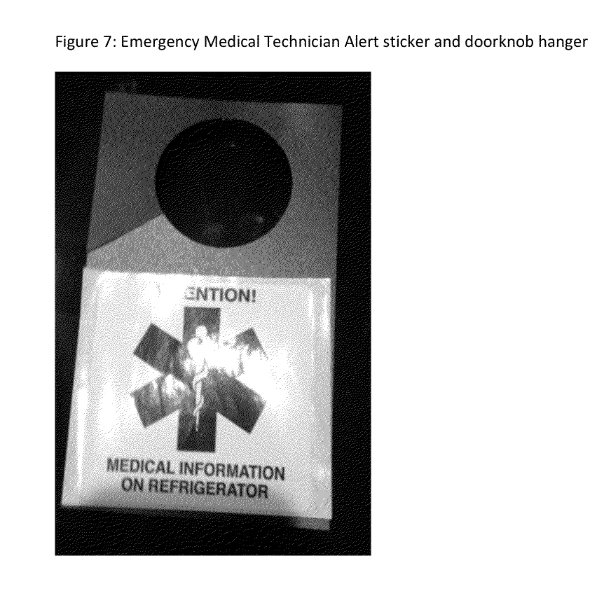

FIG. 7: The Emergency Medical Technician Alert sticker and doorknob hanger
This shows a sticker placed on a doorknob hanger. It is placed on the front door of the individual's front door. It is to notify that emergency responders that the current medical information is on the refrigerator.

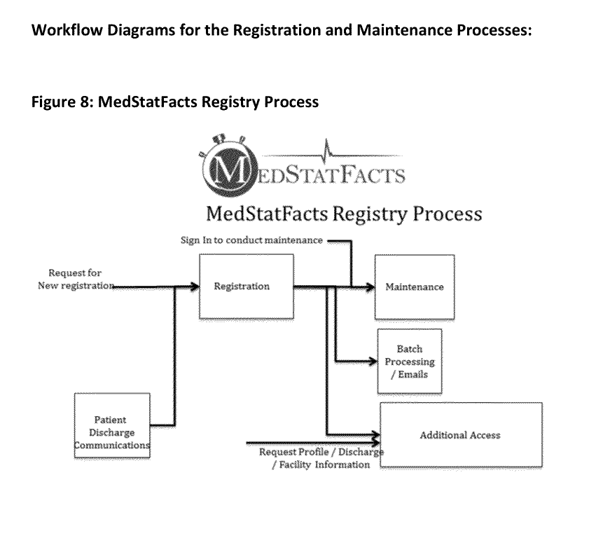

FIG. 8: The MedStatFacts Registry Process
This is an overview of the registry processes from registration to ongoing maintenance.

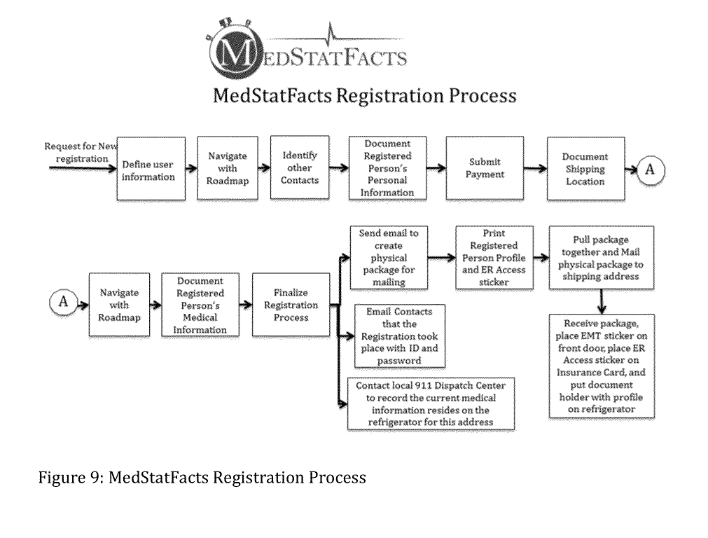

FIG. 9: The MedStatFacts Registration Process
This diagram shows the details of the registration process for entering an individual into the MedStatFacts Registry.

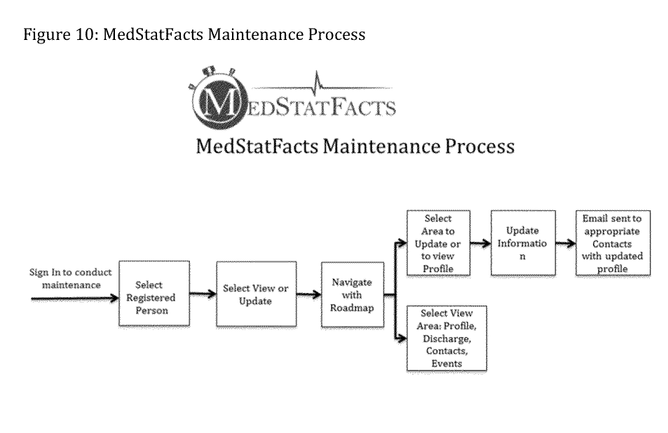

FIG. 10: The MedStatFacts Maintenance Process
This diagram shows the flow for conducting maintenance activities once a person is registered.

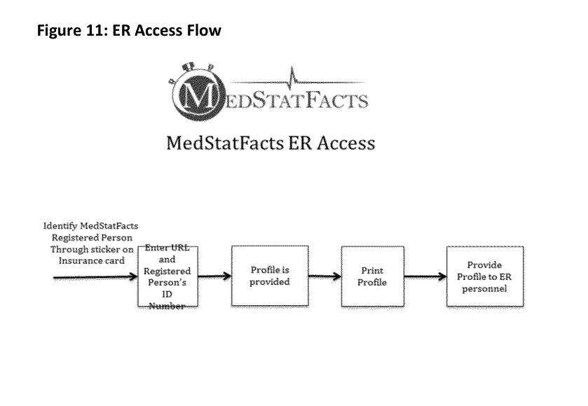

FIG. 11: The MedStatFacts ER Access
This diagrams shows the flow that would be used by Emergency Room personnel if the profile is not brought into the ER with the patient to gain access to the medical profile.

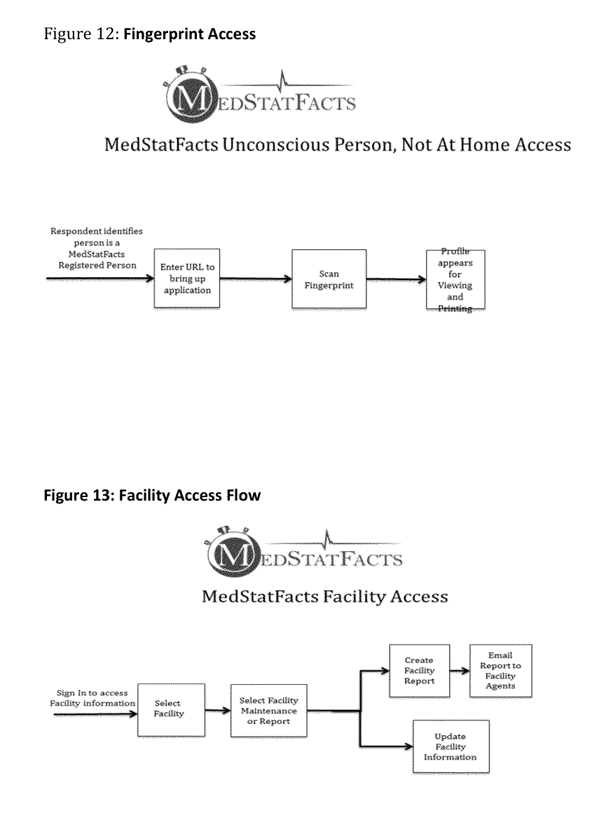

FIG. 12: Fingerprint Access Diagram
This diagram shows the flow for accessing the individual profile through fingerprint recognition.

FIG. 13: The Facility Access flow
This diagram shows the flow available to facility personnel identified at an earlier time period. Facilities include senior apartments, independent living, assisted living, rehabilitation centers, and home healthcare. This allows those personnel access to the individual's profile if access has been granted.

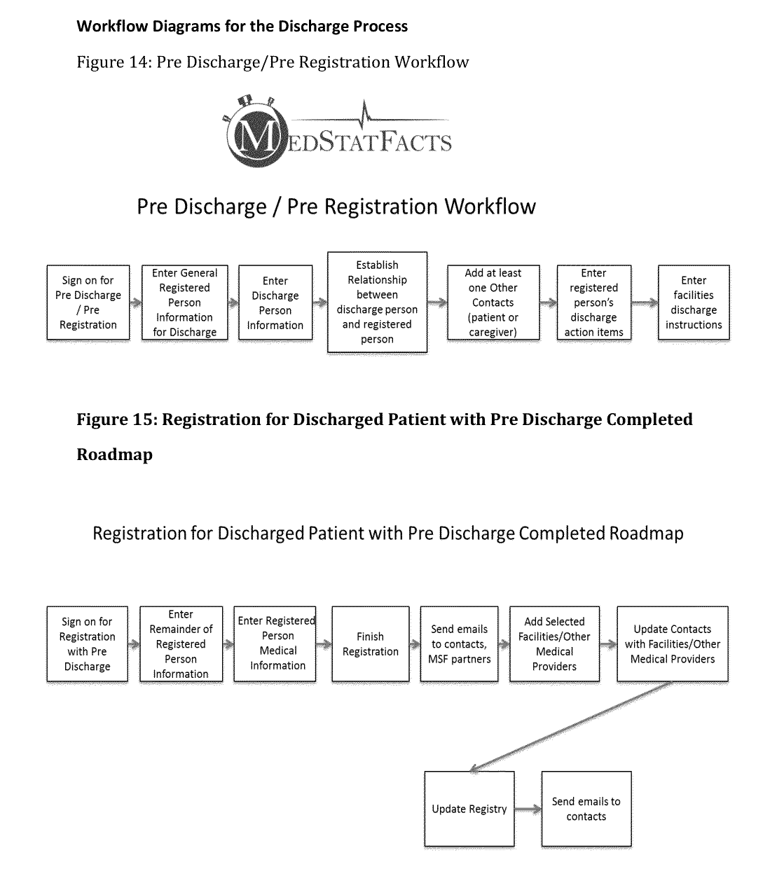

FIG. 14: The Pre Discharge/Pre-Registration Workflow Diagram
This diagram shows the process that would take place prior to a hospital discharge. This process is optional.

FIG. 15: The Registration for Discharged Patient with Pre Discharge Completed Roadmap
This diagram shows the discharge process for utilizing the registry if the pre discharge process was completed.

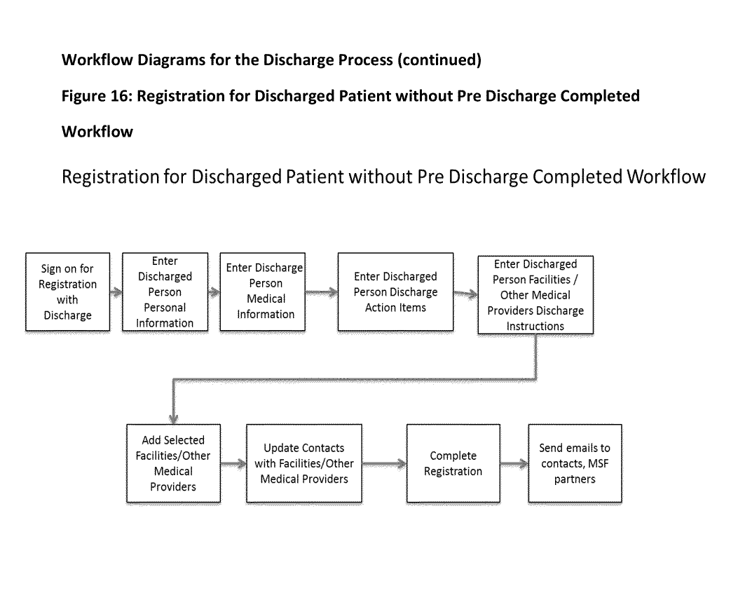

FIG. 16: The Registration for Discharged Patient without Pre Discharge Completed Workflow
This diagram shows the process during discharge for entering the registration when the pre discharge process was not done.

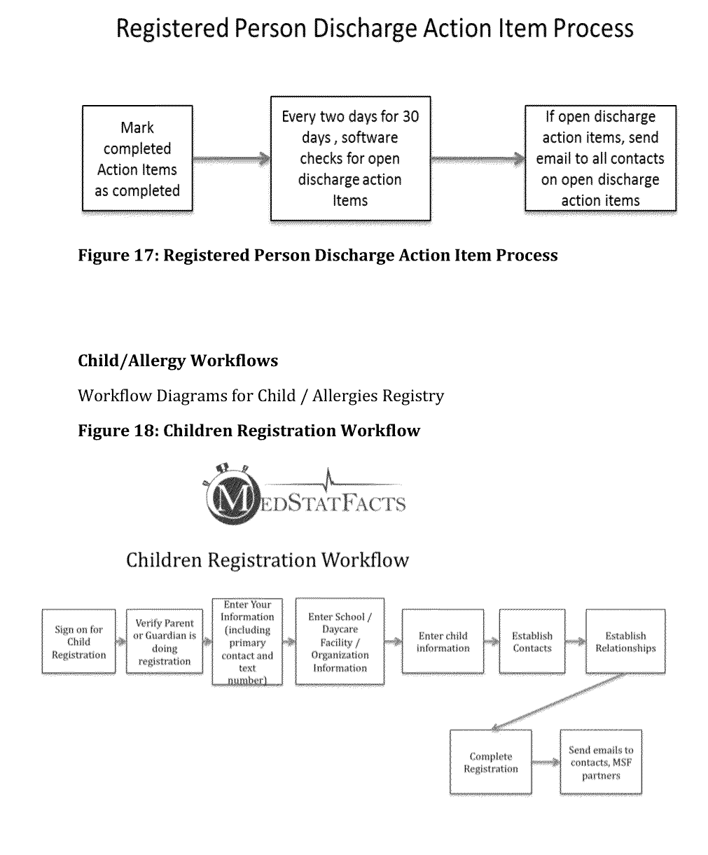

FIG. 17: The Registered Person Discharge Action Item Process
This diagrams highlights the action items that a discharged person is supposed to do once leaving the hospital. It includes reminder emails for any discharge action items not completed.

FIG. 18: The Children Registration Workflow
This diagram shows the registration process for children with allergies. This is a different section of the registry.

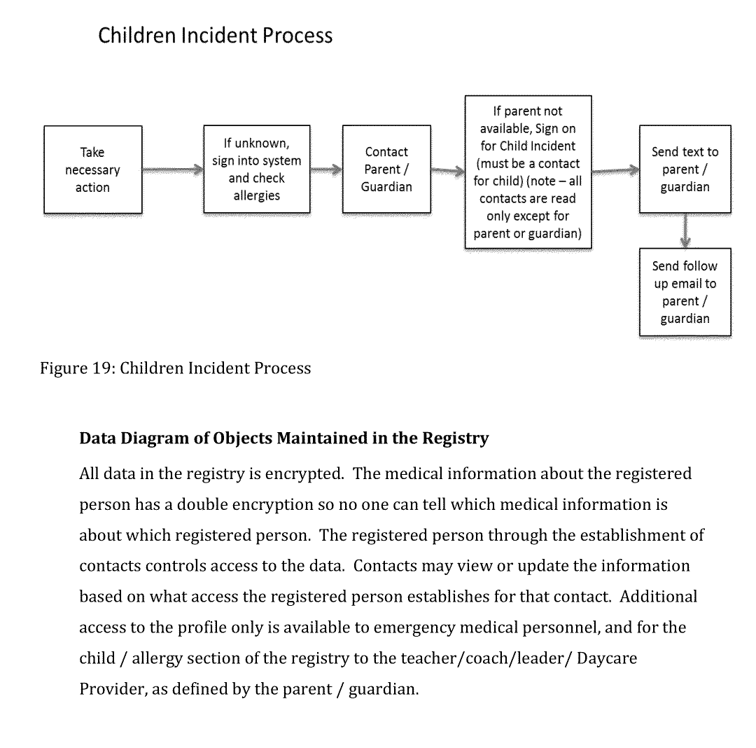

FIG. 19: The Children Incident Process Diagram
This diagram shows the flow when an allergic reaction happens to a registered child. The specific individuals this is intended for are teachers, school nurses, sports coaches, mentors, or anyone else who has responsibility for a child during a parent approved activity.

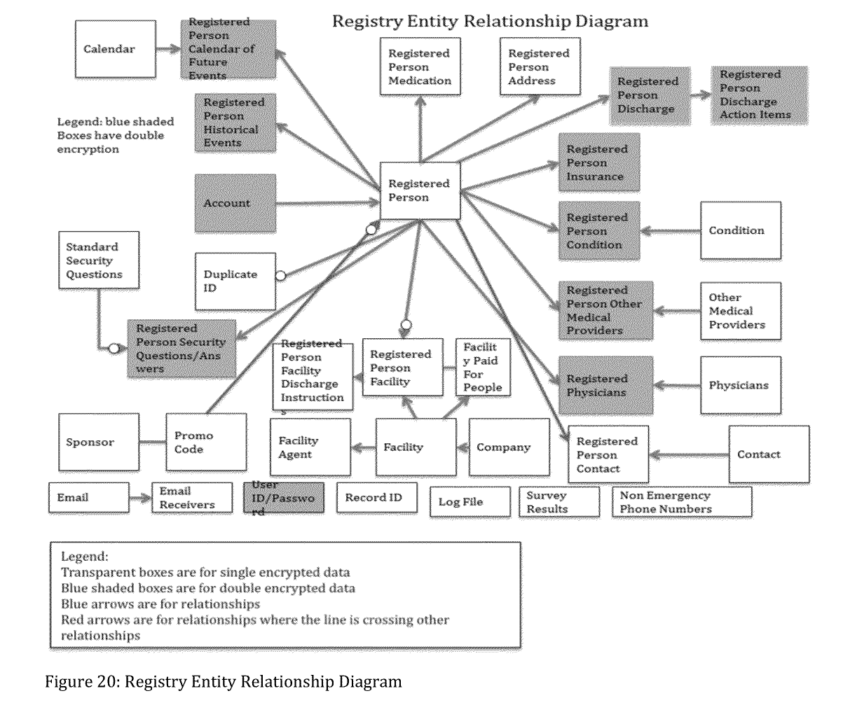

FIG. 20: The Registry Entity Relationship Diagram
This is a data model of the objects that reside in the personal medical registry. The boxes are objects and the lines show the relationships between objects. The blue boxes indicate double encryption while the red lines/arrows is showing lines that cross other lines.

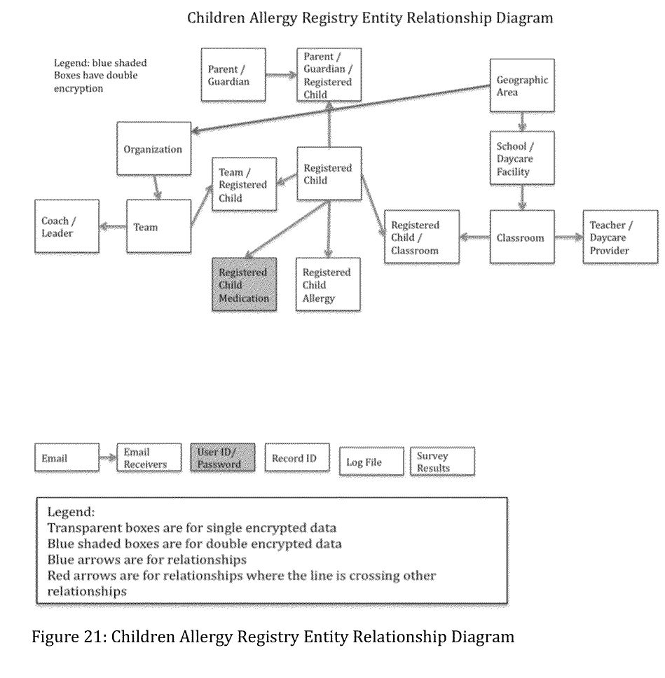

FIG. 21: The Children Allergy Entity Relationship Diagram
This is a data model for the objets within the Child/Allergy portion of the registry. The blue box indicates double encryption and the red line/arrow indicates that the line crossed another line.

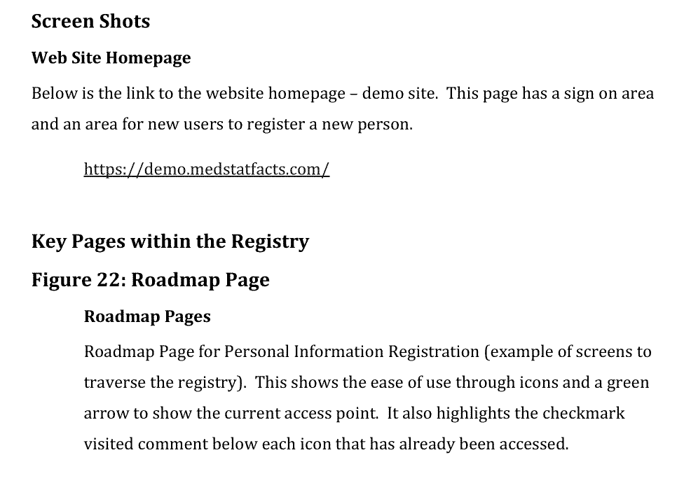

FIG. 22: The Key Pages within the Registry—Roadmap Pages
This is a screen print of our roadmap page for the first half of the initial registration. This is to highlight our unique navigational system for registration. It shows the green arrow for you are here and has icons with descriptive words to identify the subject being covered.

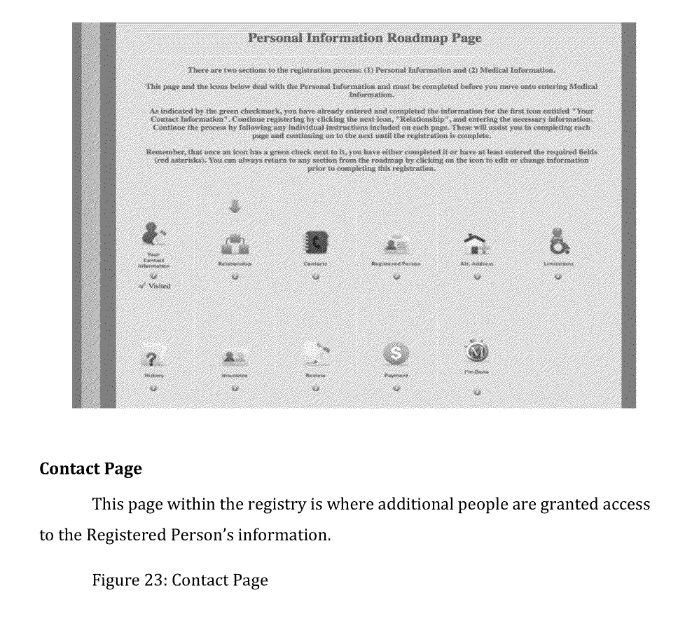

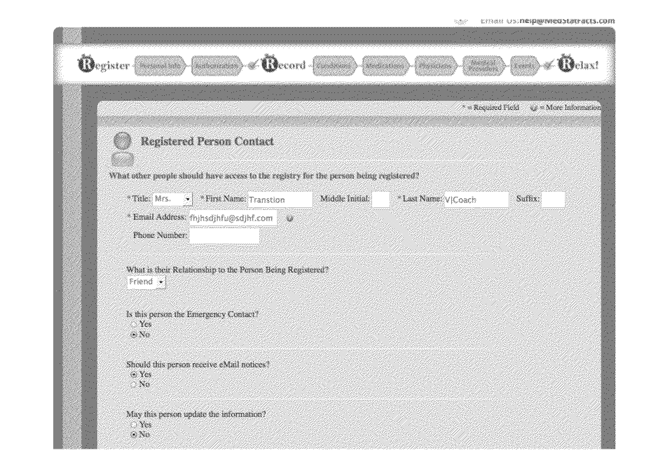

FIG. 23: The Contact Page
This is a screen print to show how contacts, people who identified as being allowed access to an individual's medical information is completed. It is unique to allow numerous individual's access to this information and is determined by the registered person.

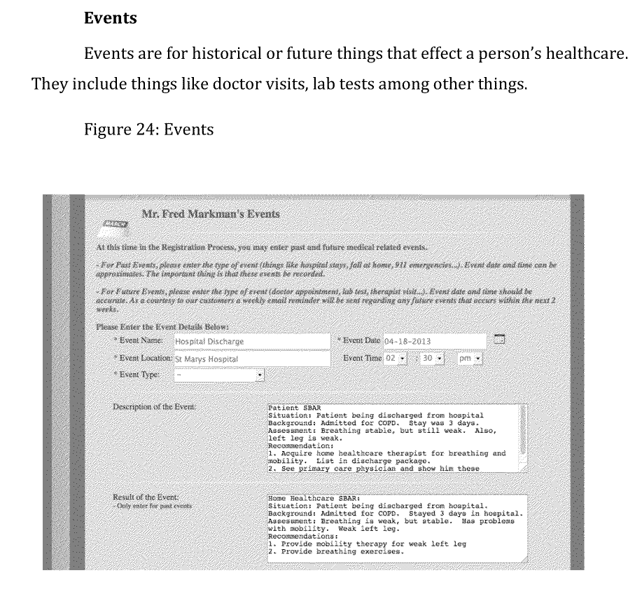

FIG. 24: The Events Picture
This is a screen shot of the events area of the registry. This allows an individual to enter past and future events and document what transpired. With future events events are sent to the contacts as a reminder of upcoming appointments or tests.

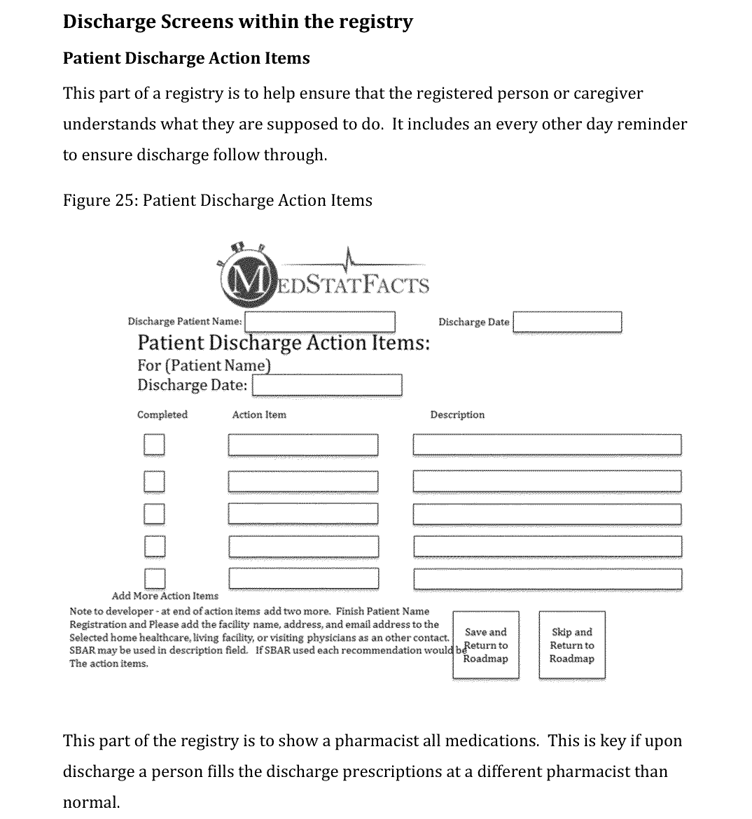

FIG. 25: The Patient Discharge Action Items
This is a picture of the screen for a given registered person that has been discharged from a hospital. It shows what action items need to be completed and a completed mark once those items are done. Emails are sent out to contacts if any action items are not completed.

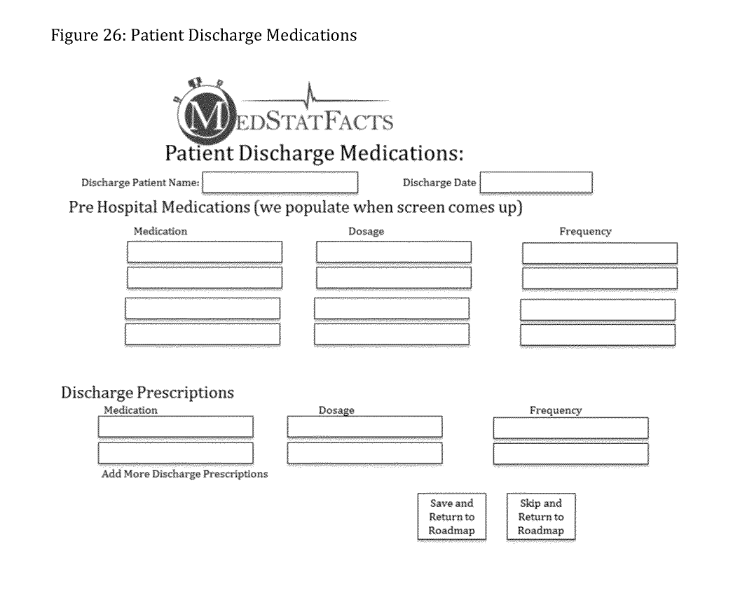

FIG. 26: The Patient Discharge Medications
This is a picture of a screen that highlights the pre hospital medications from the registry and the discharge medications. This information is to be taken to the normal pharmacist to determine if there are any drug interactions.

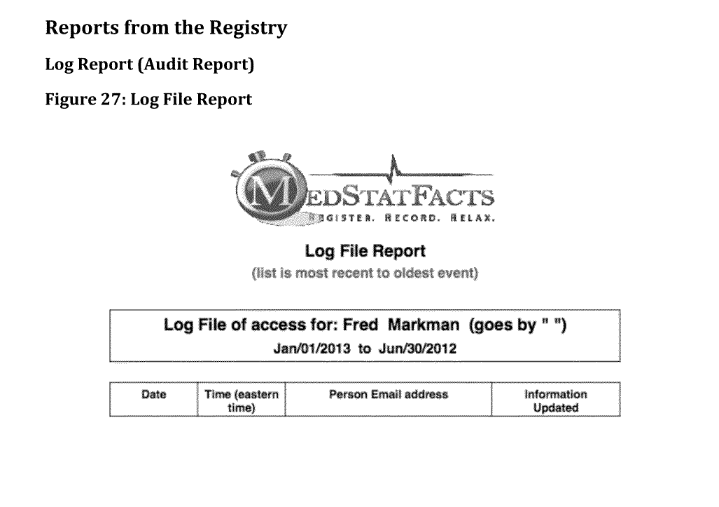

FIG. 27: The Log File Report
This is a report that shows all activity against an individual's registry for a time period.

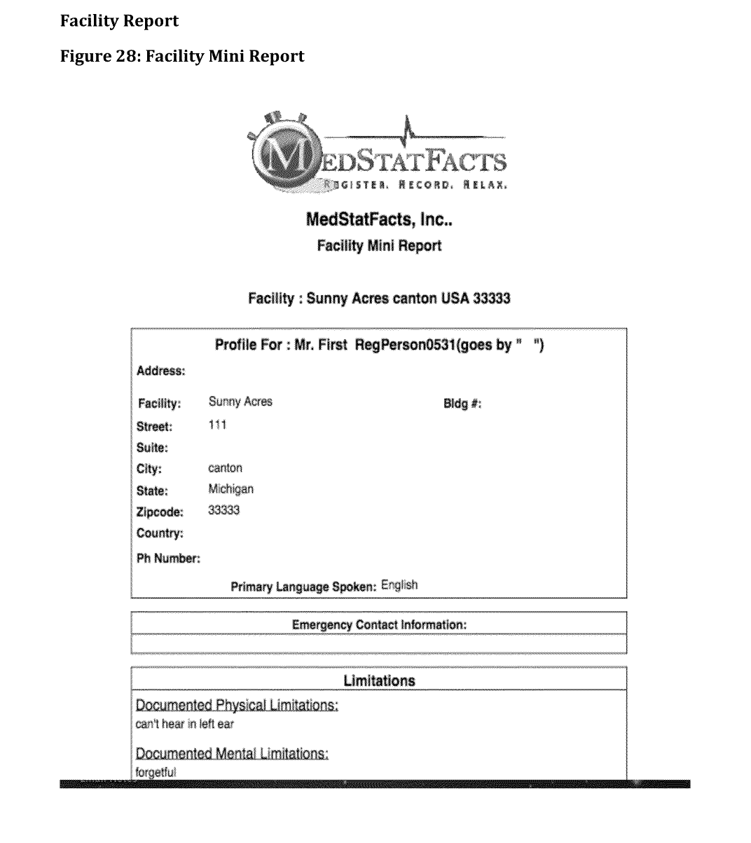

FIG. 28: The Facility Report
This is a summary report of an individual's registry for facility personnel.

### BRIEF SUMMARY OF THE INVENTION SECTION

Our invention is not the Electronic Medical Record (EMR) or the Personal Medical Record (PMR). It is the vehicle for capturing, maintaining, accessing, communicating, and integrating current critical medical information in support of emergency and discharge situations. It communicates and integrates information from the patient to emergency personnel, as well as discharge information from the medical facility to the patient, the family and other impacted healthcare providers.

The Product, The EMS Ready Kit, has two components: one for the elderly/chronically infirmed and the other for the family/caregiver
For the elderly/chronically infirmed (refer to Brief Description of Diagrams Section). This component consists of the physical portion of the product.
   Magnetic Document Holder for the refrigerator
   Doorknob hanger for the EMS Notification Sticker
   EMS Notification Sticker for the front door
   Integration with 911 Dispatch
   ER Access Sticker for the insurance card
   The Profile
For the family/caregiver
   Secure Registry with easy navigation through Roadmap pages
   For children (an extension of the registry for times the child is not under the care of his/her parent or guardian)
   Integrated Email System for notifications and reminders
   Future Event Calendar
   Contacts to control access, allowing controlled read/write access to multiple people
Integrated Discharge communications channel between the hospital and the patient, caregiver, and other medical providers such as, but not limited to, home healthcare, visiting physicians, rehabilitation centers, physicians, hospitals and facility caregivers
Easy to use secure registry through a navigational Roadmap for all access to the registry
A mobile component for access to the registered person's current critical medical information.
Fingerprint access to the registered person's profile
Integrated email system with registry
Integrated with 911 dispatch centers
Special medical personnel access to profile
Healthcare facility access to summary information in case of catastrophic events
The concept of authorized contacts. Allowing anyone defined to receive emails and to view or update the registry information
Controlled access to the child/allergy registry

### Brief Description of the Physical Components of the Invention

The diagrams below show the physical aspects of The EMS Ready Kit. The below physical components of the product are for the elderly/chronically infirmed. These include:
   The 9″×5″ document holder. It is magnetized and is to be placed on the refrigerator. It will contain two copies of the Registered Person's Profile Report. (FIG. 3)
   The Registered Person's Profile Report. (FIG. 4)
   The Emergency Room Access Sticker. This 1⅞″×½″ sticker is to be placed on either the Registered Person's insurance or identification card. (FIGS. 5 and 6)
   The Emergency Medical Technician Alert sticker. This 3″×3″ laminated sticker is to alert the emergency responders that the current medical information is on the refrigerator. It is to be placed on either the front door or on the doorknob hanger, which in turn, should be placed on the front doorknob. (FIG. 7)

Product—Document Holder (FIG. 3)

See the Document Holder in the Drawing document.
Profile Report (FIG. 4)
See the Profile Report on page 50. Emergency Room Access Sticker (FIG. 5)
   See the Emergency Room Access sticker in the Drawing document.
Emergency Room Access Sticker on Insurance Card (FIG. 6)
See the Emergency Room Access Sticker on Insurance Card in the Drawing document.
Emergency Medical Technician Alert sticker and doorknob hanger (FIG. 7)
See Emergency Medical Technician Alert sticker and door knob hanger in the Drawing document

### Detailed Description of Invention Section

The Product, The EMS Ready Kit, has two components: one for the elderly/chronically infirmed and the other for the family/caregiver
   For the elderly/chronically infirmed
      Magnetic Document Holder for the refrigerator
      Doorknob hanger for the EMS Notification Sticker
      EMS Notification Sticker for the front door
      Integration with 911 Dispatch
      ER Access Sticker for the insurance card
      The Profile
   For the family/caregiver
      Secure Registry with easy navigation through Roadmap pages
         For children (an extension of the registry for times the child is not under the care of his/her parent or guardian
      Integrated Email System for notifications and reminders
      Future Event Calendar
      Contacts to control access, allowing controlled read/write access to multiple people
   Integrated Discharge communications channel between the hospital and the patient, caregiver, and other medical providers such as, but not limited to, home healthcare, visiting physicians, rehabilitation centers, physicians, hospitals and facility caregivers
   Easy to use secure registry through a navigational Roadmap for all access to the registry
   A mobile component for access to the registered person's current critical medical information.
   Fingerprint access to the registered person's profile
   Integrated email system with registry
   Integrated with 911 dispatch centers
   Special medical personnel access to profile
   Healthcare facility access to summary information in case of catastrophic events.
   The concept of authorized contacts. Allowing anyone defined to receive emails and to view or update the registry information
   The Registry captures the following information:
      Contacts
      Contacts Relationship to Registered Person
      Registered Person's Personal Information (including a photo) as well as
         Alternate Residence
         Limitations (physical and mental)
         History
         Insurance Information
         Shipping Information
         Medical Conditions
         Allergies/Surgeries
         Physicians
         Other Medical Providers
         Events
         Discharge Action Items
         Physical Identifiers
      The child extension of the registry also captures
         Immunizations
         School/Daycare Centers
         Classroom
         Teacher
         Team
         Coach/Leader
   The software registry is a cloud-based service built on a secure modern JEE (java enterprise edition), and JME (java micro edition) web/mobile application framework, providing a natural rich client style programming model with integrated audit, alert, event, access, communication, identity and security engines.
   There are eight engines driving the software. They are:
      1. Data—captures, stores and ensures referential integrity, valid data look ups, and data clean up.
      2. Communications for mail and reminder/notification/discharge emails
      3. Alerts—monitors and notifies authorized contacts of related medical events. This includes changes to information, inactivity, not completed discharged action items, upcoming events and recently past events.
      4. Reporting—reports include Registered Person Profile, Log/Audit Trail Report, Discharge Action Item Report, Facility Mini Report (a summary report for residence of a facility), a discharge report for other medical providers, school/classroom/child report for teachers, and a team/coach-leader/child report.
      5. Security—we use a 256K bit encryption for the personal data. MedStatFacts uses a secondary encryption, on top of the first encryption for all medical information. The key to the medical information is different than the key to the personal information adding an additional layer of security. We also provide access to the registry through fingerprints.
      6. Audit—reports of all activity against the registry is available to the contacts
      7. Event—captures calendar related and medical episodes.
      8. Identity—provides authentication and authorization controls through web/mobile platforms.
The registry is different than the Electronic Health Record and Personal Health Record. We are not trying to solve all of a person's healthcare information. We exist for emergency and discharge situations. We are focused on helping people under stressful medical situations by improving communications with the patient/caregiver and medical facilities. Today, over 98% of people do not have their emergency medical information accessible. With Emergency Medical Technicians having a mini emergency room on the truck they need current information to treat individuals. Also, we need to improve patient accountability in discharge situations. By providing an action item list and sending emails every other day to all contacts there is a much greater chance that the patient will follow through on the action items. Along with that, by showing the normal pharmacists changes in medications due to a hospital stay will reduce drug interactions.
There are numerous access points into the registry. They are the normal sign on with an identifier and password, through fingerprint recognition when a person is not at home and unconscious where a PDF file of the profile is shown, a special emergency code that when entered will show a PDF file of the profile, a facility sign on to view a list of residents and create a summary report of each resident, a discharge sign on to enter the appropriate discharge action items and facility instructions, and a child/allergy sign on which only deals with the child portion of the registry.
Access to the registry and receipt of email notices/reminders are controlled by establishing contacts. Contacts may read or update the registry based upon being defined as part of the registration process. Identifying who should receive emails is also defined at that time.
We have also developed a calendar for future events. An event can be anything such as a doctor appointment, a lab test, a hospital discharge, medical episodes, surgery . . . . Emails are triggered to remind contacts of upcoming future events that occur within fourteen days. Also, as an event happens another email is sent to remind the contacts to update the results of the event.
For discharge, a hospital discharge person or a transition person may enter the patient's action items and the instructions needed by the living facility or other medical providers of the registered person. This will trigger emails to all the appropriate people regarding action items that need to be done for the discharged person as well as instructions for therapists, visiting doctors/nurses and living facilities. We continue to automatically send the discharge action item emails until all action items are completed, which is tracked by the software.
We have integrated the current medical information with the discharge information through relating dropped medications, new prescriptions, and changes to the discharged person in the one registry.
Upon a completed registration, we create and mail a package consisting of the document holder, Emergency Room Access sticker, the EMT Alert sticker, a doorknob hanger, and the first profile of the registered person. We also integrate with the local 911 dispatch system. MedStatFacts personnel contacts the local 911 dispatch center and have them add a note to the local 911 system. When an emergency call comes in from a certain address the emergency responders will know that the current medical information resides on the refrigerator.
Our process is the key. We have integrated the current medical information in case of an emergency with the information from a facility discharge. Technology is a key component of the process. Email notifications and reminders will help keep the information maintained.

Additional Access to the Registry/Registered Person's Profile
Below are the access paths to the Registry beyond normal sign on.
   Emergency Room Access to Profile
      This is for the Emergency Room administrator. On the insurance or identification card of the registered person the ER Access sticker will contain a URL and ID that can be entered into our system and the profile of the person will be available for viewing or printing. The only access to the registry is during the sign on process. Once there is successful sign on the registry is exited and the PDF file is created.
   Facility Access
      The facility (independent living, rehabilitation center, assisted living, home healthcare, visiting physician, visiting nursing, nursing home, or hospice) can sign into our system and access a summary profile report of all people that are in our registry that reside at their facility or that are responsible for the registered person's healthcare.
   Discharge Process
      This is for access for communicating discharge instructions from the discharge facility (typically a hospital) to receiving organizations/people (the patient/caregiver, independent living, assisted living, home healthcare, rehabilitation centers, nursing homes, other hospitals, or hospice). This process includes entering the discharge action items/instructions as well as, obtaining the profile through a PDF file of the registered person.
   Registered Person—not at home, unconscious, and there is no access to insurance card
      You can access the person's profile through their fingerprint. You do not enter the registry. Only a PDF report file of the registered person is created.
   Parent/Guardian access to child/allergy information
      A parent or guardian may access through a special url for this information.

### Integrated Email System

Emails consist of reminders and notifications. They are sent to the appropriate contacts, based on whether the contact is flagged to receive emails.

### Emails

Daily (sent every other day)
   Open Discharge Action Items for Patient/Caregiver for the first 60 days after discharge
Weekly
   Updated profile,
   Notification of future events within the next 14 days, and
   Past events that happened within the past 7 days to update the results of the event
Monthly
   Email to appropriate contacts where the registry has not been updated for the past 30 days
Annually
   In October, reminder to change/verify Medicare insurance
On demand
   An email is sent to organizations that need discharge instructions for a registered person. Organizations include other hospitals, home healthcare, independent living facilities, rehabilitation centers, visiting doctors, visiting nurses, assisted living facilities, nursing homes, and hospice care.

Workflow Diagrams for the Registration and Maintenance Processes:

See MedStatFacts Registry Process, MedStatFacts Registration Process (FIG. 9), and MedStatFacts Maintenance Process (FIG. 10) in the Drawing document.

### ER Access Flow

See MedStatFacts ER Access (FIG. 11) in the Drawing document.

### Fingerprint Access

See MedStatFacts Unconscious Person, Not At Home Access (FIG. 12) in the Drawing document.

### Facility Access Flow

See MedStatFacts Facility Access (FIG. 13) in the Drawing document.

### Workflow Diagrams for the Discharge Process

See the Pre Discharge/Pre Registration workflow (FIG. 14) and the Registration for Discharged Patient with Pre Discharge Completed Roadmap (FIG. 15) in the Drawing document.

### Workflow Diagrams for the Discharge Process (Continued)

See the Registration for Discharged Patient without Pre Discharge Completed Workflow (FIG. 16) and the Registered Person Discharge Action Item Process (FIG. 17) in the Drawing document.

### Child/Allergy Workflows

See the Children Registration workflow (FIG. 18) and the Children Incident Process (FIG. 19) in the Drawing document

Workflow Diagrams for Child/Allergies Registry

### Data Diagram of Objects Maintained in the Registry

See Registry Entity Relationship Diagram (FIG. 20) and Child/Allergy Diagram (FIG. 21) in the Drawing document.

All data in the registry is encrypted. The medical information about the registered person has a double encryption so no one can tell which medical information is about which registered person. The registered person through the establishment of contacts controls access to the data. Contacts may view or update the information based on what access the registered person establishes for that contact. Additional access to the profile only is available to emergency medical personnel, and for the child/allergy section of the registry to the teacher/coach/leader/Daycare Provider, as defined by the parent/guardian.

### Screen Shots

### Web Site Homepage

Below is the link to the website homepage—demo site. This page has a sign on area and an area for new users to register a new person.
https://demo.medstatfac
   Key Pages within the Registry

### Roadmap Pages

See Roadmap screen (FIG. 22) in the Drawing document
Roadmap Page for Personal Information Registration (example of screens to traverse the registry). This shows the ease of use through icons and a green arrow to show the current access point. It also highlights the checkmark visited comment below each icon that has already been accessed.

### Contact Page

See Contact screen (FIG. 23) in the Drawing document.
This page within the registry is where additional people are granted access to the Registered Person's information.

### Events

See Events screen (FIG. 24) in the Drawing document
Events are for historical or future things that effect a person's healthcare. They include things like doctor visits, lab tests among other things.
   Discharge Screens within the Registry

### Patient Discharge Action Items

See Patient Discharge Action Items (FIG. 25) in the Drawing document.

This part of a registry is to help ensure that the registered person or caregiver understands what they are supposed to do. It includes an every other day reminder to ensure discharge follow through.

### Discharge Output on Medications

See Patient Discharge Medications (FIG. 26) in the Drawing document.

This part of the registry is to show a pharmacist all medications. This is key if upon discharge a person fills the discharge prescriptions at a different pharmacist than normal.

### Email Examples

### Past Event Email

Below is the email sent for past events. This email is sent weekly to appropriate people where an event has past within the last 7 days.

Hello,

As part of registering Mr. Fred Markman in the MedStatFacts Registry, as a courtesy you will receive weekly reminders of past week events for Mr. Fred Markman. List events that happened in the previous 7 days:

| | | Event | | |
|---|---|---|---|---|
| Date: | Time: | Name: | Event Description: | Event Results: |
| Jun. 7, 2013 | 4:00 | Hospital | Patient Discharge Action Items: 1. Get | Discharge Instructions for |
| | PM | Discharge | therapy for breathing. List of therapist | Other Healthcare providers 1 |
| | | | companies and prescription are in the | vitals 2 last time fed |
| | | | discharge package. 2. Get therapy for your | medications given by |
| | | | weak left let. List of therapist companies | medication breathing therapy |
| | | | and prescription are in the discharge | left leg weakness therapy 3 |
| | | | package. 3. Medication—stop taking zocor | change in diet. No salt 4 |
| | | | 4. Medication—start taking xxxxxxx— | provide therapy on weak left |
| | | | prescription is in discharge package 5. | leg. Leg is weak do to bed |
| | | | Medication—start taking yyyyyyyyyyyy— | ridden for last 4 days 5 |
| | | | prescription is in discharge package. 6. | breathing has improved but |
| | | | Update the registry for the new | needs therapy 6 watch for |
| | | | medications, and the new conditions 7. If | slurred speech |
| | | | you fill your medicine prescriptions at a | |
| | | | different pharmacy, after you update the | |
| | | | registry, print the registry and take it to your | |
| | | | normal pharmacist and ask him if there are | |
| | | | any drug interactions between your current | |
| | | | medication and the new discharge | |
| | | | prescription medications. 8. See your | |
| | | | primary care physician and take with you | |
| | | | the updated registry 9 Life style change— | |
| | | | quit smoking | |
| Jun. 11, 2013 | 9:00 | dr appt | ${ev.evtDescription} | |
| | AM | | | |

Please be sure to update Mr. Fred Markman's registry with any changes or updates.

### Upcoming Event Email

Below is the email sent for future events. This email is sent weekly to the appropriate people where an event is upcoming within the next 14 days

Hello,

As part of registering Mr. Fred Markman in the MedStatFacts Registry, as a courtesy you will receive weekly reminders of upcoming events that have been entered for Mr. Fred Markman. Over the next week, the following events are scheduled:

| Date: | Time: | Event Name: | Event Description: |
|---|---|---|---|
| Jun. 20, 2013 | 3:00 PM | Lab Test | No Description |

If you need more details on these events, please refer to the MedStatFacts Calendar of Events that can be found by simply logging into the Medstatfacts registry.

If you have any questions, please send all inquiries to test.help@medstatfacts.com.

Thank you,

MedStatFacts

### Changed Registry Information Email

Below is the email sent for changes to the registry. This email is sent weekly to the appropriate people where information in the registry has changed.

Hello,

There have been updates to Mr. Fred Markman's profile over the past 7 days. Attached you will find a link to a log file of who made the changes and whether any emergency medical personnel accessed the information.

1. The integration of discharge and emergency medical information in support of emergency and release of patient situations in one centralized cloud based registry.

2. An integrated email system with a medical registry that provides notifications and reminders to all people that are allowed access to the registry information.

3. Integrating the emergency and discharge processes through integrated information (point 1) and integrated communications (point 5)

4. Controlled access to the registry through a list of contacts. This list regulates who may view/update the information in the registry.

5. Controlled email reminders and notifications through each contacts defined profile.

6. Roadmap pages utilized to provide simple to use navigation through the registration and maintenance processes. This includes notifying the user is they have already visited subjects and at what current subject that is next for processing during registration.

7. The invention includes two components: one that has physical components (document holder, profile, Emergency Medical Technician Alert sticker (with door knob hanger), and an Emergency Room Access sticker that is placed on either an insurance or identification card). The automated component that is a cloud based registry of personal medical information.

8. An electronic medical calendar that is integrated with the email notification system. This allows the notifications of upcoming appointments and medical tests.

9. Capturing discharge instructions and translating those instructions into action items that generate reminder every other day emails to all contacts and patient until all action items are completed.

10. A discharge process for capturing discharge instructions as part of the registry that is integrated with the emergency medical registry that instructs the contacts/patient to verify drug interactions for new medications with their normal pharmacist.

11. Through fingerprinting technology we can identify the patient. Also, we are capturing unique physical characteristics to help identify the person such as birthmarks, photos, and other distinguishing physical characteristics.

12. Integration with the 911 local Dispatch Center, so the 911 system will communicate to emergency first responders that current medical information is on the refrigerator.

13. Email reminders to contacts for registry inactivity. This will help ensure that the current medical information is maintained.

14. Provides access to child allergy information when children are away from home.

15. If a medical emergency occurs away from the house, medical information is not readily available to emergency room personnel or first responders. Through our emergency room sticker placed on an insurance or identification card, the medical personnel can access the current medical information online and print the medical profile of the patient. Part of claim 7.
